(19) United States
(12) Patent Application Publication
(10) Pub. No.: US 2026/0330122 A1
(43) Pub. Date: Oct. 22, 2026

(54) Method for Evaluating Originality of A Written Composition and A System Thereof

(71) Applicant: Daedalean Education PTE LTD, Singapore (SG)

(72) Inventors: Jia Xuan Ho, Singapore (SG); Min Wee Kong, Singapore (SG)

(21) Appl. No.: 19/136,521

(22) PCT Filed: Jul. 5, 2024
(86) PCT No.: PCT/SG2024/050441

§ 371 Date: Jun. 6, 2025

(51) Int. Cl. G06F 40/166; G06F 11/34; G06F 40/103

(52) U.S. Cl. CPC G06F 40/166; G06F 11/3438; G06F 40/103

(57) ABSTRACT

A method for evaluating originality of a written composition including a plurality of text strings is provided. Method includes receiving the plurality of text strings, such that each of the plurality of text strings includes one or more words, spacings between the words and/or a punctuation, determining a typing duration of each of the plurality of text strings, receiving at least one edit instruction to edit at least one of the plurality of text strings, and determining the originality of the plurality of text strings based on the typing duration and the number of edit instructions. A system of the method is provided.

### TECHNICAL FIELD

The present invention relates to a method for evaluating originality of a written composition and a system thereof.

### BACKGROUND

When a composition is written, e.g. student essays in school, the written composition is usually delivered in its completed form. Academic assessment typically focuses on the quality of the text produced as the end product. While handwritten composition has traces of composing activity in terms of corrections or cancellations, typewritten composition is printed and submitted in hardcopy and devoid of such traces. Even in electronic format, e.g. Microsoft™ Word and PDF format, it is not possible to know if the composition is original or copied. This problem is exacerbated by the emergence of Generative Artificial Intelligence (GenAI) tools, rendering it difficult to assess whether a typewritten composition is done by the student, i.e. whether the composition is original or composed by the student.

Currently, it is not possible for someone to know whether a composition is original or copied using word processing applications, e.g. Microsoft™ Word and Google™ Docs Draftback. While there are GenAI detection tools available, they are not reliable in detecting the originality of the composition.

Due to this problem, it is difficult or impossible for someone, e.g. a teacher, to assess if the student has composed the composition on his or her own or copied it from another source, e.g. GenAI tools.

Hence, it is important to provide a solution to overcome the abovementioned problem.

### SUMMARY

According to various embodiments, a method for evaluating originality of a written composition including a plurality of text strings is provided. Method includes receiving the plurality of text strings, such that each of the plurality of text strings includes one or more words, spacings between the words and/or a punctuation, determining a typing duration of each of the plurality of text strings, receiving at least one edit instruction to edit at least one of the plurality of text strings, and determining the originality of the plurality of text strings based on the typing duration and the number of edit instructions.

According to various embodiments, the plurality of text strings is original if the typing duration is above a typing duration threshold.

According to various embodiments, the plurality of text strings is original if the number of edit instructions is higher than an edit number threshold.

According to various embodiments, the method further includes recording each pause between each of the plurality of text strings and transforming the pauses into a frequency of pauses, such that the determination of the originality of the plurality of text strings includes basing on the frequency of pauses.

According to various embodiments, the plurality of text strings is original if the frequency of pauses is close to or coincides with a natural frequency of a pauses.

According to various embodiments, the pause may be recorded if it is longer than 2 seconds.

According to various embodiments, the at least one edit instruction may include a delete instruction, backspace instruction or undo instruction.

According to various embodiments, the method may further include displaying each of the plurality of text strings with one or more shades of highlight based on the number of edit instructions received for each of the plurality of text strings.

According to various embodiments, the one or more shades of highlight may be further based on duration of the pauses.

According to various embodiments, the method further includes recording the at least one edit instruction and its related data if one of a plurality of conditions is fulfilled.

According to various embodiments, the plurality of conditions may include:
a) the text string includes a punctuation at the end of the text string;
b) a pause that is longer than 2 seconds;
c) a plurality of sentences with a punctuation inserted between the plurality of sentences;
d) two sentences merged after a punctuation is deleted;
e) an edit in the text string; and
f) a copy-and-paste instruction is received.

According to various embodiments, a system for evaluating originality of a written composition including a plurality of text strings is provided. System includes a processor; and a memory in communication to the processor for storing instructions executable by the processor, such that the processor is configured to receive the plurality of text strings, such that each of the plurality of text strings includes one or more words, spacings between the words and/or a punctuation, determine a typing duration of each of the plurality of text strings, receive at least one edit instruction to edit at least one of the plurality of text strings, and determine the originality of the plurality of text strings based on the typing duration and the number of edit instructions.

According to various embodiments, the plurality of text strings is original if the typing duration is above a typing duration threshold.

According to various embodiments, the plurality of text strings is original if the number of edit instructions is higher than an edit number threshold.

According to various embodiments, the processor may be further configured to record each pause between each of the plurality of text strings and transform the pauses into a frequency of pauses, such that the determination of the originality of the plurality of text strings includes basing on the frequency of pauses.

According to various embodiments, the plurality of text strings is original if the frequency of pauses is close to or coincides with a natural frequency of a pauses.

According to various embodiments, the pause may be recorded if it is longer than 2 seconds and not longer than 7 seconds.

According to various embodiments, the at least one edit instruction may include a delete instruction or backspace instruction.

According to various embodiments, the processor may be further configured to display each of the plurality of text strings with one or more shades of highlight based on the number of edit instructions received for each of the plurality of text strings.

According to various embodiments, the one or more shades of highlight may be further based on duration of the pauses.

According to various embodiments, the processor may be configured to record the at least one edit instruction and its related data if one of a plurality of conditions is fulfilled.

According to various embodiments, the plurality of conditions may include:
a) the text string includes a punctuation at the end of the text string;
b) a pause that is longer than 2 seconds;
c) a plurality of sentences with a punctuation inserted between the plurality of sentences;
d) two sentences merged after a punctuation is deleted;
e) an edit in the text string; and
f) a copy-and-paste instruction is received.

According to various embodiments, a non-transitory computer readable storage medium comprising instructions, such that the instructions, when executed by a processor in a system, cause the system to receive the plurality of text strings, such that each of the plurality of text strings includes one or more words, spacings between the words and/or a punctuation, determine a typing duration of each of the plurality of text strings, receiving at least one edit instruction to edit at least one of the plurality of text strings, and determine the originality of the plurality of text strings based on the typing duration and the number of edit instructions.

### BRIEF DESCRIPTION OF DRAWINGS

FIG. 1 shows a flow diagram of an exemplary method for evaluating originality of a written composition which includes a plurality of text strings.

FIG. 2 shows a schematic diagram of an exemplary embodiment of a system for evaluating originality of a written composition which includes a plurality of text strings.

FIG. 3 shows an exemplary embodiment of a display of a written composition on the multimedia module.

FIG. 4A shows an exemplary flow diagram of a method of receiving and processing the plurality of text strings.

FIG. 4B shows a table representing a measure of the degree of edit of the plurality of text strings based on the number of edit instructions.

FIG. 4C shows a table representing another measure of the degree of edit of the plurality of text strings based on the number of edit instructions and duration of pauses.

FIG. 5 shows an example of a screenshot of the word processor with a composition having a plurality of text strings entered into the word processing interface.

FIG. 6A-6D shows an example of the log of the method of processing the text strings shown in FIG. 5.

FIG. 7 shows an example of the heat map of the composition as shown in FIG. 5.

FIG. 8 shows an example of a graph for the cumulative duration of the edit instructions based of each sentence in the composition in FIG. 5.

FIG. 9 shows an example of a table of data presented in the graph in FIG. 8.

FIG. 10 shows an example of a graph for the number of pauses of the composition in FIG. 5.

FIG. 11 shows an example of a table of data presented in the graph in FIG. 10.

### DETAILED DESCRIPTION

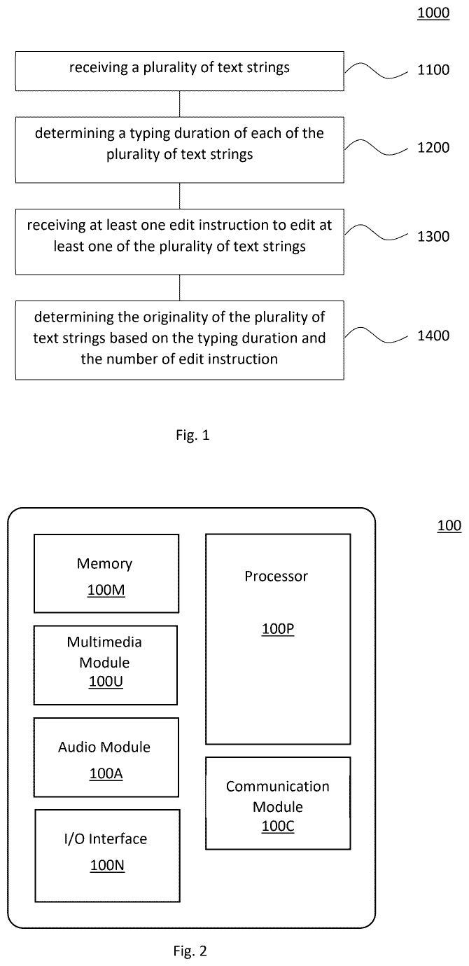

FIG. 1 shows a flow diagram of an exemplary method 1000 for evaluating originality of a written composition which includes a plurality of text strings. Referring to FIG. 1, the method includes receiving a plurality of text strings in block 1100. Each of the plurality of text strings includes one or more words, spacings between the words and/or a punctuation. Method further includes determining a typing duration of the plurality of text strings in block 1200, receiving at least one edit instruction to edit at least one of the plurality of text strings in block 1300, and determining the originality of the plurality of text strings based on the typing speed and the number of edit instructions in block 1400. Method 1000 may be a computer implemented method. Method 2000 may record the typing speed of each of the plurality of text strings instead of the typing duration and determine the originality of the plurality of text strings based on the typing speed and number of edit instructions.

Method 1000 enables a temporal analysis of a user's behavior in the process of writing. Based on the user's typing behaviour, data is collected in terms of edits and alterations to the text strings and the data can provide important statistics in temporal analysis. The measurement of cognitive load requires temporal framing for accurate analysis of the user's writing behaviour. In other words, temporal analysis gives insights into the user's cognitive thought process and situational awareness in terms of text string production. Hence, temporal analysis is especially important in identifying natural and unnatural writing based on the typing speed, i.e. duration of the time spent on the text strings, and the number of edits within the duration of the writing, i.e. text string production. Method 1000 is able to measure the entire composition of the text production and offers an assessor, e.g. teacher, an overview/in-depth insight into the writing process of the users, e.g. students.

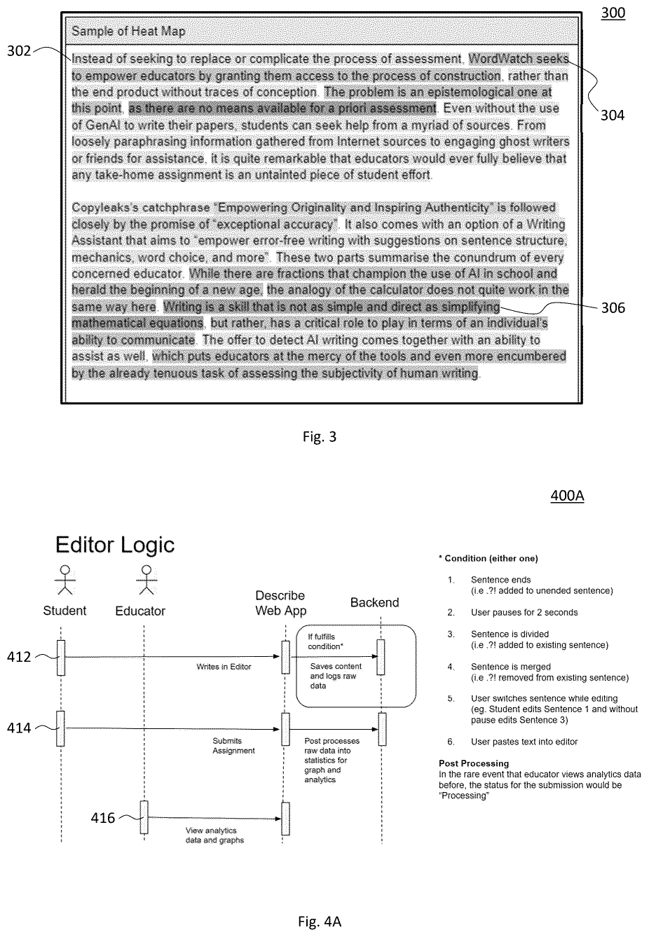

FIG. 2 shows a schematic diagram of an exemplary embodiment of a system 100 for evaluating originality of a written composition which includes a plurality of text strings. System 100 may include a processor 100P, a memory 100M in communication to the processor 100P for storing instructions executable by the processor 100P, at least one of a multimedia module 100U configured to display a word processing interface, an audio module 100A configured to input/output audio signals, an input/output (I/O) interface 100N configured to provide an interface between the processor 100P and peripheral interface modules, e.g. keyboard, and a communication module 100C configured to facilitate communication between the system 100 and other devices or server. System 100 may include a storage module, e.g. a database, cloud server, configured to store data.

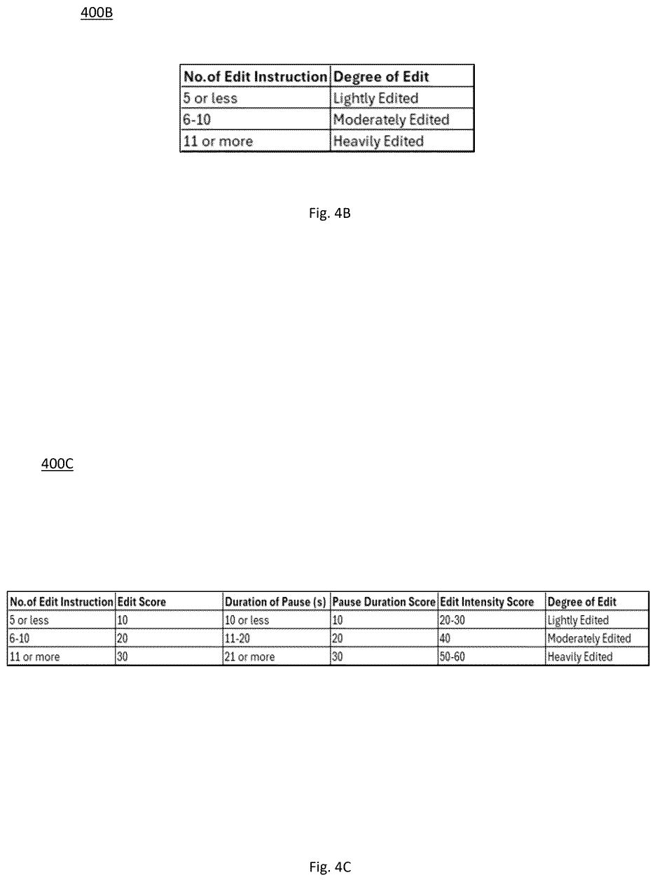

FIG. 3 shows an exemplary embodiment of a display 300 of a written composition on the multimedia module 100U. System 100 provides a word processing environment or word processor which enables the user to use the system 100 like any other word processing platforms. System 100 may receive the plurality of text strings when a user enters them via the keyboard. Plurality of text strings may be stored in the memory and displayed on the multimedia module 100U, i.e. display 300. As shown in the text string 302, “Instead of seeking to replace or complicate the process of assessment”, each text string may include a plurality of words and spacings between the words. Each text string may also include a punctuation therein and/or at the end thereof. A punctuation may include a terminal punctuation, e.g. a period, exclamation mark; a separating punctuation, e.g. a comma, dashes; or a balanced punctuation, e.g. parentheses. It is important to note that the system 100 evaluates text strings and not keystrokes. Based on each text string entered, the system 100 is configured to record the data related to the text string, e.g. duration for typing each text string, number of words, number of pauses, event type, number of sentences, number of edit instructions, duration between each text string, etc.

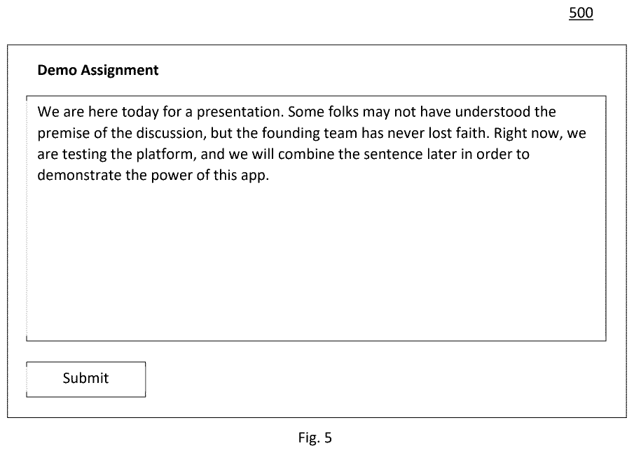

FIG. 4A shows an exemplary flow diagram of a method 400A of receiving and processing the plurality of text strings. As shown in FIG. 4A, a user, e.g. a student, may enter one or more text strings in a word processor, i.e. a word editor, at step 412. System 100 is configured to receive the plurality of text strings entered. After receiving the plurality of text strings, the system 100 is configured to process them. System 100 may be configured to record an edit instruction and its related data if one or more conditions is fulfilled. The conditions may include: a text string comprising a sentence with a punctuation (e.g. period, comma, question mark, exclamation mark, colon, semicolon, ellipsis); a pause that is longer than 2 seconds; a plurality of sentences with a punctuation inserted between the plurality of sentences; two sentences merged after a punctuation is deleted; an edit in the text strings (e.g. when a user edits a sentence or a number of sentences); a copy-and-paste instruction (when a user paste a text from external sources), etc. An edit may include a change made to a sentence, e.g. backspace, delete, or insertion of text. User may submit the composition when it is completed at step 414. System 100 may receive a “submit” instruction and upon receiving the instruction, the system 100 may process the data and generate statistical data based on the data and the statistical data may be further analysed and/or converted to graphs. An assessor, e.g. instructor/specialist, may view the data, statistical data, graphs, etc to assess the user at step 416.

FIG. 4B shows a table 400B representing a measure of the degree of edit of the plurality of text strings based on the number of edit instructions. System 100 may include a plurality of edit number thresholds and the processor 100P may determine the degree of edits based on the number of edit instructions recorded against the plurality of edit number thresholds. For example, the edit number thresholds may be 5 or less edit instructions for “light edited”, 6-10 edit instructions for “moderate edited”, 11 or more edit instructions for “heavily edited”. As mentioned, the same method is applicable to a text string. Edit number threshold may be varied according to necessity in terms of assessment requirement. System 100 may record the duration of each edit instruction. Edit number threshold may also be used to determine if the sentence is original. For example, if the number of edit instructions in a sentence is less than an edit number threshold of 3, the system 100 may determine the sentence to be copied. On the other hand, if the number of edit instructions is higher than the edit number threshold, the system 100 may determine that the sentence is original. The edit number threshold may be adjusted to vary bar for originality.

FIG. 4C shows a table 400C representing another measure of the degree of edit of the plurality of text strings based on the number of edit instructions and duration of pauses. System 100 may determine the degree of edit based on the number of edit and duration of pauses. Processor 100P may combine the number of edit instructions and duration of pauses in the plurality of text strings to determine the degree of edit in the plurality of text strings. For this embodiment, the process 100P may generate an edit score based on number of edit instructions and determine the degree of edit based on the edit score and a pause duration score based on the duration of pauses. Duration of pauses may be the combined duration of all the pauses in the text string or plurality of text strings. Process 100P may combine the edit score and pause duration score to calculate an edit intensity score and derive a degree of edit based on the edit intensity score. Referring to FIG. 4C, for example, if the number of edit instructions is 7 and the duration of pauses is 15 seconds, the edit score and the pause duration score would be 20 and 20 respectively. Hence, the edit intensity score would be 40, which refers to “Moderately Edited”. As such, processor 100P may record degree of edit for the plurality of text strings as “Moderately Edited”. Alternatively, the degree of edit may be based on the duration of the edit instruction, e.g. 0-2 s is lightly edit, 3-15 s is moderately edit, 16 s and above is heavily edited.

System 100 may be configured to display each of the plurality of text strings with one or more shades of highlight based on the number of edit instructions received for each of the plurality of text strings. As shown in FIG. 3, the plurality of text strings are highlighted in different shades. As an example, the shades may be based on the number of edit instructions received for the text string. Referring to FIG. 3, the text string 302 has a light shade as it is lightly edited, the text string 304 has a medium shade as it is moderately edited, the text 306 has a dark shade as it is heavily edited. The shade of highlight may also be based on the degree of edit. In this way, it will be clearly shown to the assessor the degree of edit made so that the originality of the text string can be assessed instantly. For example, the darker the highlight, the higher the likelihood that the text string is original. The highlights may be shown throughout the whole written composition, like a heat map that illustrates the degree of edit for each of the plurality of text strings or sentences.

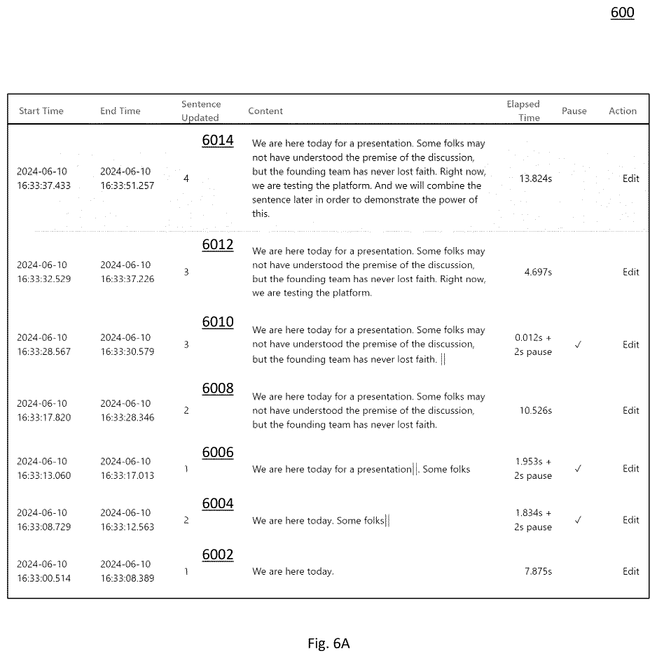

FIG. 5 shows an example of a screenshot 500 of the word processor with a composition having a plurality of text strings entered into the word processing interface. User may enter the plurality of text strings and the system 100 is configured to record the plurality text strings and data in the storage module upon fulfilment of any one of the above conditions. A detailed method is shown below.

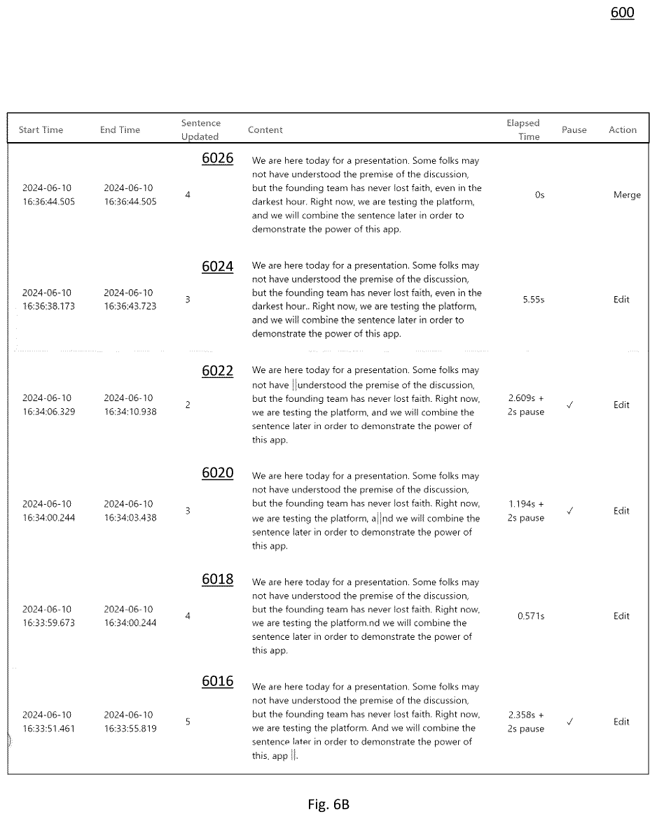

FIG. 6A-6D shows an example of the log 600 of the method of processing the text strings shown in FIG. 5. This example exhibits how the system 100 recognises the text strings and records the data related thereto. The log shows the earliest records at the bottom of the log and the latest record at the top of the log. When the user enters a first text string as shown in record 6002, the text string is recorded as a first sentence as it ends with a terminal punctuation, i.e. a period. Alternatively, the system 100 may be configured to record a sentence if a terminal punctuation and a spacing or an “enter” (i.e. return) instruction. System 100 records the date and time when the text string begin and end and based on the date and time data calculates and records a first duration taken to complete the first sentence, i.e. 7.875 s. System 100 also records the event as an edit instruction. Thereafter, the user enters a second text string and no input was received for more than 2 s. System 100 records the second duration and a pause and the event as another edit instruction in record 6004. As the second text string was entered after the punctuation, the system 100 records the second text string as a second sentence. At this juncture, the user goes back to the first sentence and added a third text string, i.e. “for a presentation” followed by a pause. System 100 records a duration and a pause and the event as another edit instruction in record 6006. System 100 identifies that the edit instruction was received for the first sentence and shows that the sentence is being updated is the first sentence, i.e. sentence “1”. As the system 100 did not receive a terminal punctuation at the end of the second text string, the system 100 did not record the text string as a sentence. The user then continues with the second text string and inputs a fourth text string followed by a terminal punctuation. System records the duration of the fourth text string and an edit instruction event in the second sentence in record 6008. Although not shown in record 6010, the user enters a fifth text string and deleted it and paused for a while. System 100 records the fifth text string and the pause as record 6010. Accordingly, the system 100 records the input as a third sentence in record 6010. User then inputs a sixth text string, i.e. “Right now, ...” , followed by a terminal punctuation, i.e. a period, and the system 100 records the duration of the input and the event as an edit event in record 6012. When the user enters a seventh text string with a terminal punctuation, the system 100 records the same data for the seventh text string and the seventh text string as the fourth sentence in record 6014.

Referring to FIG. 6B, the user then inserted a terminal punctuation after the word, “this” in the fourth sentence. As a insertion is an edit instruction, the system 100 records the duration taken, a pause and an edit instruction in record 6016. As the edit instruction was made to the fifth sentence, i.e. the sentence after “this.”, the system 100 identifies the sentence updated is “5”, i.e. the 5th sentence. Thereafter, the user deleted the terminal punctuation after “this” and deleted the space and letter “A”. Accordingly, the system 100 records the duration and the event as an edit instruction in record 6018. The user then replaced the period in the third sentence with a separating punctuation, i.e. comma, and inserted a spacing and the letter “a” followed by a pause of 2 s. As the terminal punctuation was changed to a separating punctuation, i.e. comma, the system 100 recognizes that the fourth sentence has been merged with the third sentence and records the sentence as the third sentence. Accordingly, the system 100 records the duration, the pause, and the edit instruction in record 6020. Thereafter, the user made an input in the second sentence and paused, and the system stored the activity as record 6022. System 100 also identifies and shows that the edit instruction was made to the second sentence, i.e. sentence updated “2”. The user then inserted a eighth text string, “even in the darkest hour”, in the second sentence, separating the eighth text string by a comma and added two periods. Accordingly, the system records the duration of the insertion and the pause in record 6024. As there is another period added, the system 100 records another sentence being formed, i.e. fourth sentence, and identifies the edit instruction is made in the third sentence in record 6024. The user then realised that there are 2 periods in the sentence and deleted one of them. System 100 then records the deletion of the period and that it is made at the fourth sentence and its duration in record 6026. As the period is being deleted, the system 100 identifies that a merge has taken place and records the merge of the third and fourth sentences as the event in record 6026.

Referring to FIG. 6C, the user then decides to amend the second sentence and deleted some words followed by a pause. System 100 records the deletion and pause in record 6028. Thereafter, the user decides to add to the second sentence but accidentally inserted two periods. System 100 records the activity as an edit instruction and the duration of the edit in record 6030. Due to the two periods, the system 100 records another sentence being formed, e.g. third sentence “3” and identifies the edit instruction to be made in the third sentence. The user realised that there are two periods in the same second sentence and deleted one of the periods. System 100 records the duration and the event as a merging event in record 6032. The user then deletes a part of the second sentence and paused. As such, the system 100 records the duration, the pause and the edit instruction in record 6034. User then amends the second sentence and paused again. System 100 hence records the amendment duration, the pause and edit instruction as record 6036.

Referring to FIG. 6D, the user continues to finish the composition and the system 100 records the events as edit events and its durations and the number of pauses in record 6038 to record 6042. User may click on the “Submit” button in FIG. 5 to submit the composition after the user completes the composition.

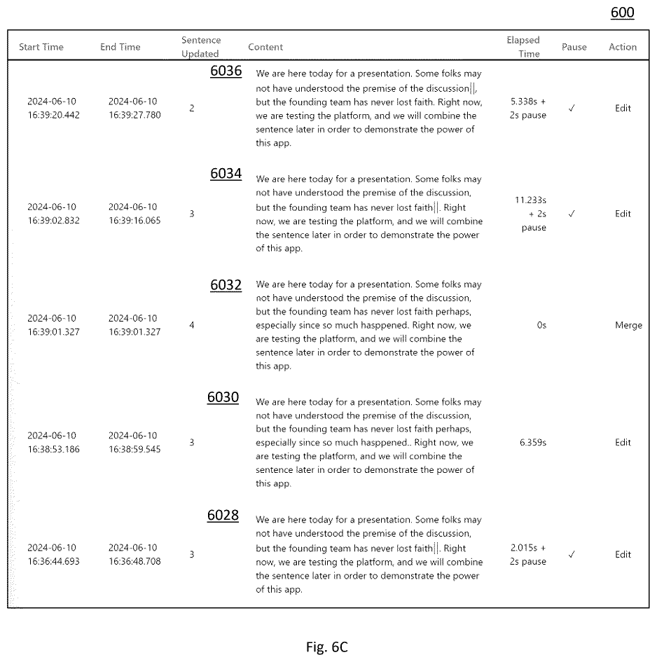

FIG. 7 shows an example of the heat map 700 of the composition as shown in FIG. 5. As mentioned, the shades may be based on the number of edit instructions. In addition, the shades may be based on duration of the plurality of edit instructions received for the plurality of text strings or sentences. In this example, the shades are based on the duration of the edit instructions. For example, the shades darkens from 0-2 s, 3-15 s, 16-45 s to more than 45s. The shade of highlight may also be based on the degree of edit.

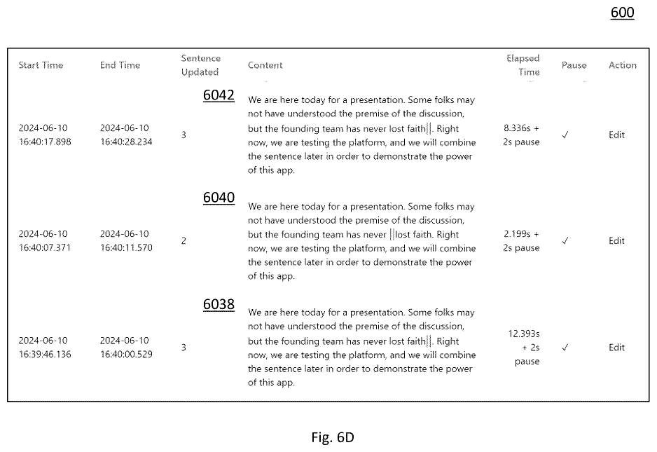

FIG. 8 shows an example of a graph 800 for the cumulative duration of the edit instructions based of each sentence in the composition in FIG. 5. As shown in FIG. 8, the cumulative duration the edit instructions of the first sentence is 9.828 s. In addition, the graph shows the duration of each edit instruction in each sentence via the shades of each edit in the graph. As explained above, the number of edit instructions may be an indication of the originality of the text string or sentence. The lower the number, the higher the probability of the text string or sentence not being original.

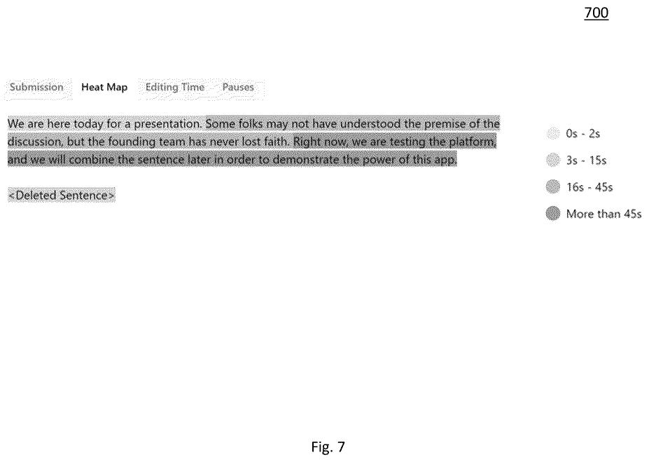

FIG. 9 shows an example of a table 900 of data presented in the graph 800 in FIG. 8. As shown in FIG. 9, the first sentence has two edit instructions, the durations of first edit instruction and second edit instruction are 7.875 s and 1.953 s respectively. Cumulatively, the durations of the first and second edit instructions are 9.828 s. Similarly, the edit instruction data for the subsequent sentences are shown in the table 900. The duration of the edit instructions are also shown in the log 600.

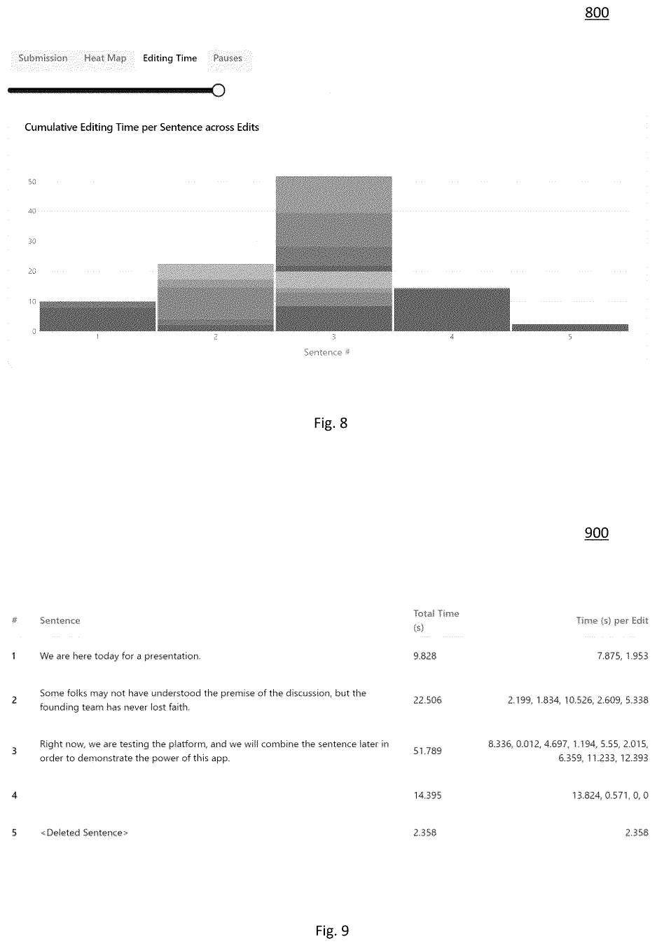

FIG. 10 shows an example of a graph 1000 for the number of pauses of the composition in FIG. 5. As shown in FIG. 10, the number of pauses for each sentence is shown, e.g. the first sentence has 1 pause, the second sentence has 4 pauses, so on and so forth.

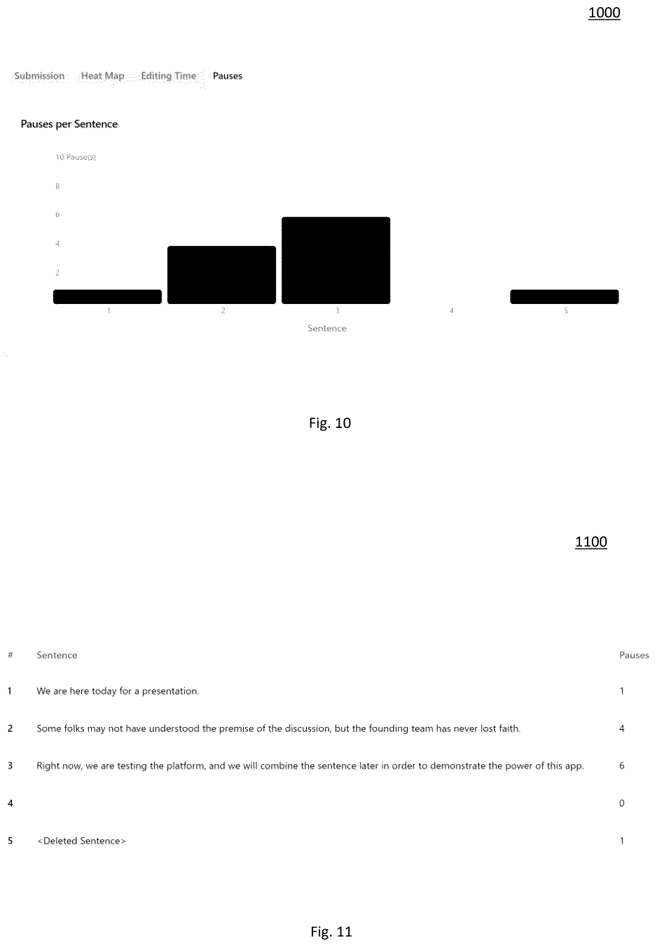

FIG. 11 shows an example of a table 1100 of data presented in the graph 1000 in FIG. 10. As shown in FIG. 11, the number of pauses for the first sentence and second sentence are 1 and 4 respectively. Similarly, the data of the number of pauses for the subsequent sentences are shown in the table 1100.

System 100 may be configured to determine the originality of the plurality of text strings or sentences based on the typing duration, and the number of edit instructions. When the text string is received, the processor 100P may be configured to determine the typing duration of the text string or sentence. Alternatively, instead of the typing duration, the system 100 may record the typing speed of the text string. Processor may also be configured to determine the typing speed of a plurality of text strings or sentences, e.g. a paragraph. A typing speed based on each text string may provide a more accurate measurement of the typing speed per sentence while a typing speed based on a plurality of text strings may provide an average typing speed of the plurality of text strings. Typing speed may be measured based on the number of words against the typing duration, e.g. words per minute (WPM). When the typing duration is above a typing duration threshold or when the typing speed is below a typing speed threshold, e.g. 20 WPM (is a normal person's typing speed), the system 100 determines that the plurality of text strings is original. The typing speed or duration recorded indicates the amount of time spent in each text string. If the duration is long, it may indicate the user's struggle with the content. On the other hand, if the duration is short, it may indicate that the user is rushing the work. The quality of writing can be assessed based on either of the above indications to determine the resource-management of the user. Further, the typing speed or duration may indicate whether the text strings are produced naturally or unnaturally. For example, a large text string produced in short period of time, e.g. 1 s, is an indication of copy-and-paste of the text string. If a large text string is produced in a short period of time and with few edits, it can indicate that the user copied the text string from an external source.

Typing speed or duration provides a fundamental assessment of a user's writing proficiency when triangulated with two factors: writing accuracy in terms of language based on academically-recognised standards and content, which may be assessed by the assessor manually. Typing speed may vary according to different groups of users. For example, the average typing speed of each specific group of users in any assigned class, e.g. according to their respective levels of education, can be tabulated and used as a form of measurement of their writing proficiency when triangulated with writing accuracy and content. Using the average typing speed, a typing speed threshold can be selected based on the user group to determine if the one or more text strings are original. For example, when a plurality of text strings are copied and pasted into the composition, the typing speed will be below a typing speed threshold and the system 100 may flag that the one or more text strings are not original. Hence, the plurality of text strings is original if the typing speed is below a typing speed threshold.

Processor 100P may be configured to receive at least one edit instruction to edit the plurality of text strings. Edit instruction may include a delete instruction, backspace instruction, undo instruction, addition of text, etc. When a user wishes to remove a text string after typing, the user may either delete the text string by pressing the delete or backspace button on the keyboard, or input an undo instruction, e.g. Ctrl+“Z”. User may also enter a text string as an edit instruction. When the processor 100P receives such an instruction, the processor 100P is configured to record the edit instruction. In this way, the system 100 is able to record the points or locations of the edits in the written composition. System 100 may indicate the difference between the various points in the written composition. System 100 may be configured to determine that the plurality of text strings is original if the number of edit instructions is higher than an edit number threshold. For example, when one or more text strings are copied and pasted, the processor 100P will receive zero edit instruction for the one or more text strings. If the user types the one or more text strings while copying directly from a reference, e.g. GenAI generated text, the processor 100P will record zero or low number of edit instructions for the one or more text strings. Correspondingly, text strings created by the user will naturally have more edit instructions, which indicates more human intervention in the construction of the text strings. If there is a high number of edits, it may indicate more resources is being invested in the production of the text strings, i.e. the user spends more time and effort in writing the composition. This data may be used together with the duration of each text string to derive a more accurate indication.

After a text string is received by the system 100, a pause may be recorded if the pause exceeds a minimal pause threshold before the next keystroke or text string is received. For example, the minimal pause threshold may be 2 second (which is the academically recognised standard), such that a pause is recorded if it is longer than 2 seconds before the next keystroke or text string is received. System 100 may stop the recording if the pause exceeds a maximal pause threshold. For example, the maximal pause threshold may be 5 seconds, such that the system 100 stop recording the pause if it is longer than 5 seconds. Maximal pause threshold may be 6 seconds, 7 seconds, etc. System 100 may be configured to record the duration of the pauses and maintain a log of the durations. User may input into the system 100 a cut-off time for the maximal pause threshold. Frequency of pauses is recognised academically as indicators of cognitive processes (within a certain time frame). It can also contribute to the measurement of duration spent on certain portions of writing, which is the academically recognised standard.

Pauses may be transformed into a frequency of pauses. Frequency of pauses can be used to verify that a piece of writing is produced by human as it is natural for human writers to have pauses. For example, a natural frequency will have a regular sequence of pauses of different lengths, while an unnatural sequence of pauses with consistent rhythm would suggest/imply that the writing is copied based on an existing reference. Having a scatter plot graph of pauses enables assessment of the linearity of writing. Hence, the plurality of text strings is original if the frequency of pauses is close to or coincides with a natural frequency of a pauses. System 100 may be able to determine the originality of the plurality of text strings based the frequency of pauses, in addition to the typing speed and number of edit instructions. The number of pauses may indicate the points of thoughts in the text strings.

The average individual has an academically recognised natural writing accuracy or writing efficiency of approximately 92%. Writing frequency is the number of edits divided by the number of characters typed. This would provide a good indicator of whether this was human written. A GenAI written essay would have more than 95% accuracy, especially if chunks of words are copied and pasted. Low accuracy in terms of writing may indicate a user's struggle with a particular task or thinking/writing in general. On the other hand, a high accuracy may indicate suspicious behaviour in the production of composition. The data from writing efficiency can be additionally combined with writing pauses/speed and external evaluation of the written content to give an overview of the user's writing ability in terms of productivity.

System 100 may be configured to receive an evaluation score from the assessor who evaluates the content of the written composition. As described above, the evaluation score when calculated with the writing accuracy and typing speed generates writing proficiency.

Processor 100P may be configured to determine if a text string or sentence is original, i.e. not copied. When a text string is received after the user inputs it, the processor 100P determines the typing speed or typing duration and records the number of edit instructions in the text string. If the typing duration is lower than a typing duration threshold or the typing speed exceeds the typing speed threshold, the processor 100P determines that the text string is not original. If the number of edit instructions is less than an edit number threshold, the processor determines that the text string is not original. Hence, if the typing speed is below the typing speed threshold and the number of edit instructions is more than the edit number threshold, the processor 110P is configured to determine that text string is original. While this example refers to a text string or sentence, the same is applicable to a plurality of text strings or sentences, i.e. the written composition.

Besides assessing the originality of the written composition, the present system 100 and method addresses the current problem with the assessment of written composition, e.g. essays, paper, in institutions, as it can be used to track student activity during the process of typing. The data collected from the user's writing process can be processed to determine whether the user created the content or with assistance from GenAI tools, which makes it critically important for assessment purposes. More importantly, the tool can be utilised for pedagogical purposes as well, as it allows educators to diagnose potential writing problems through the review of the writing process of each composition. Collecting the data from users' text production and translating them into different visual representations creates potential opportunities for dialectical constructivism, a pedagogical approach which focuses on the co-creation of knowledge between the individual and his/her environment. By allowing student users to be cognitively aware of how the processes of their text production takes place, this concept allows both assessors and users to review, reflect and reassess the whole learning process (which in this case is the text production/essay). Metacognition, which in layman terms simply means thinking about one's thinking, is thus a possibility. In other words, this concept allows possibilities of metacognition in terms of writing processes, which can align/complement other more recognised forms of metacognitive activity.

These various activities, i.e. typing speed, typing duration, edits, pauses, etc. are indicators of the users' potential cognitive activity when typing out a composition. System 100 and method 1000 empowers assessor to assess whether a piece of written composition is natural and human-written so that potential cases of GenAI-assisted writing or plagiarism cases are addressed. This concept is aligned with the concept of authentic learning which has been gaining traction in institutions of higher learning. Authentic learning requires students to be cognitively aware of whether what they learn in terms of theory can translate to practical application. Further, the system 100 and method 1000 also empowers the user, e.g. student, to determine the user's level of cognitive activity at specific portions of the written composition, highlighting the potentially problematic areas of their decision-making (word choices, sentence structure, sequence/paragraphing etc) that allow correction and further instruction. Hence, in cases where the highlighted portions is revealed to the students, opportunities for metacognition (a higher level of situational awareness) is generated, leading to further opportunities for critical thinking instruction and assessment. Naturally, this transcends the issues of GenAI and plagiarism-related problems.

System 100 may include a mobile device, e.g. a mobile phone, tablet, laptop, a computer, etc.

Processor 100P typically controls overall operations of the system 100, such as the operations associated with display, telephone calls, data communications, view operations, and recording operations. The processor 100P may include one or more processor to execute instructions to perform all or part of the steps in the above described methods. Moreover, the processor 100P may include one or more modules which facilitate the interaction between the processor 100P and other modules. System 100 may be in communication with a server via a network.

Memory 100M may be configured to store various types of data to support the operation of the system 100. For example, the data may include instructions for any applications or above methods operated on the system, contact data, phonebook data, messages, pictures, video, etc. Memory 100M may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

Multimedia module 100U may include a screen providing an output interface between the system 100 and the user. In some embodiments, the screen may include a liquid crystal display (LCD), organic light-emitting diode (OLED), a touch panel, etc. If the screen includes the touch panel, the screen may be implemented as a touch screen to receive input signals from the user. Touch panel may include one or more touch sensors to sense touches, swipes, and gestures on the touch panel. The touch sensors may not only sense a boundary of a touch or swipe action, but also sense a period of time and a pressure associated with the touch or swipe action.

Audio module 100A may be configured to output and/or input audio signals. For example, the audio module 100A may include a microphone (“MIC”) configured to receive an external audio signal when the system 100 is in an operation mode, such as a call mode, a recording mode, and a voice recognition mode. The received audio signal may be further stored in the memory 100M or transmitted via the communication module 100C. In some embodiments, the audio module 100A further includes a speaker to output audio signals.

I/O interface 100N provides an interface between the processor 100P and peripheral interface modules, such as a keyboard, a click wheel, buttons, and the like.

Communication module 100C may be configured to facilitate communication, wired or wirelessly, between the system 100 and other devices or the server. System 100 may access a wireless network based on a communication standard, such as WiFi, 2G, or 3G, LTE, and 4G cellular technologies or a combination thereof. In one exemplary embodiment, the communication module 100C may receive a broadcast signal or broadcast associated information from an external broadcast management system via a broadcast channel. In one exemplary embodiment, the communication module 100C may further include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

A skilled person would appreciate that the features described in one example may not be restricted to that example and may be combined with any one of the other examples.

The present invention relates to a method for evaluating originality of a written composition and a system thereof generally as herein described, with reference to and/or illustrated in the accompanying drawings.

1. A method for evaluating originality of a written composition comprising a plurality of text strings, the method comprising:
receiving the plurality of text strings, wherein each of the plurality of text strings comprises one or more words, spacings between the words and/or a punctuation,
determining a typing duration of each of the plurality of text strings,
receiving at least one edit instruction to edit at least one of the plurality of text strings, and
determining the originality of the plurality of text strings based on the typing duration and the number of edit instructions.

2. The method according to claim 1, wherein the plurality of text strings is original if the typing duration is above a typing duration threshold.

3. The method according to claim 1, wherein the plurality of text strings is original if the number of edit instructions is higher than an edit number threshold.

4. The method according to claim 1, wherein the method further comprises recording each pause between each of the plurality of text strings and transforming the pauses into a frequency of pauses, wherein the determination of the originality of the plurality of text strings includes basing on the frequency of pauses.

5. The method according to claim 4, wherein the plurality of text strings is original if the frequency of pauses is close to or coincides with a natural frequency of a pauses.

6. The method according to claim 4, wherein the pause is recorded if it is longer than 2 seconds.

7. The method according to claim 1, wherein the at least one edit instruction comprises a delete instruction, backspace instruction or undo instruction.

8. The method according to claim 1, wherein the method further comprises displaying each of the plurality of text strings with one or more shades of highlight based on the number of edit instructions received for each of the plurality of text strings.

9. The method according to claim 8, wherein the one or more shades of highlight is further based on duration of the pauses.

10. The method according to claim 1, further comprising recording the at least one edit instruction and its related data if one of a plurality of conditions is fulfilled.

11. The method according to claim 10, wherein the plurality of conditions comprises:
a) the text string comprises a punctuation at the end of the text string;
b) a pause that is longer than 2 seconds;
c) a plurality of sentences with a punctuation inserted between the plurality of sentences;
d) two sentences merged after a punctuation is deleted;
e) an edit in the text string; and
f) a copy-and-paste instruction is received.

12. A system for evaluating originality of a written composition comprising a plurality of text strings, the system comprises:
a processor; and
a memory in communication to the processor for storing instructions executable by the processor,
wherein the processor is configured to:
receive the plurality of text strings, wherein each of the plurality of text strings comprises one or more words, spacings between the words and/or a punctuation,
determine a typing duration of each of the plurality of text strings, and
receive at least one edit instruction to edit at least one of the plurality of text strings,
determine the originality of the plurality of text strings based on the typing duration and the number of edit instructions.

13. The system according to claim 12, wherein the plurality of text strings is original if the typing duration is above a typing duration threshold.

14. The system according to claim 12, wherein the plurality of text strings is original if the number of edit instructions is higher than an edit number threshold.

15. The system according to claim 12, wherein the processor is further configured to record each pause between each of the plurality of text strings and transform the pauses into a frequency of pauses, wherein the determination of the originality of the plurality of text strings includes basing on the frequency of pauses.

16. The system according to claim 15, wherein the plurality of text strings is original if the frequency of pauses is close to or coincides with a natural frequency of a pauses.

17. The system according to claim 15, wherein the pause is recorded if it is longer than 2 seconds and not longer than 7 seconds.

18. The system according to claim 12, wherein the at least one edit instruction comprises a delete instruction or backspace instruction.

19. The system according to claim 12, wherein the processor is further configured to display each of the plurality of text strings with one or more shades of highlight based on the number of edit instructions received for each of the plurality of text strings.

20. The system according to claim 19, wherein the one or more shades of highlight is further based on duration of the pauses.

21. The system according to claim 12, wherein the processor is configured to record the at least one edit instruction and its related data if one of a plurality of conditions is fulfilled.

22. The system according to claim 21, wherein the plurality of conditions comprises:
a) the text string comprises a punctuation at the end of the text string;
b) a pause that is longer than 2 seconds;
c) a plurality of sentences with a punctuation inserted between the plurality of sentences;
d) two sentences merged after a punctuation is deleted;
e) an edit in the text string; and
f) a copy-and-paste instruction is received.

23. A non-transitory computer readable storage medium comprising instructions, wherein the instructions, when executed by a processor in a system, cause the system to:
receive the plurality of text strings, wherein each of the plurality of text strings comprises one or more words, spacings between the words and/or a punctuation,
determine a typing duration of each of the plurality of text strings,
record at least one edit instruction to edit at least one of the plurality of text strings, and
determine the originality of the plurality of text strings based on the typing duration and the number of edit instructions.
